(19) United States
(12) Patent Application Publication
(10) Pub. No.: US 2004/0193698 A1
(43) Pub. Date: Sep. 30, 2004

(54) Method for finding convergence of ranking of web page

(76) Inventor: Sadasivuni Lakshminarayana, Visakhapatnam (IN)

Correspondence Address: Supervisor, Patent Prosecution Services, PIPER RUDNICK LLP, 1200 Nineteenth Street, N.W., Washington, DC, 20036-2412, US

(21) Appl. No.: 10/394,147

(22) Filed: Mar. 24, 2003

(51) Int. Cl. G06F 15/16

(52) U.S. Cl. 709/218; 715/501.1

(57) ABSTRACT

The present invention provides a computer-based method for finding convergence of ranking of a page in the process of assigning weight to a ranking parameter belonging to a web page said method comprising assigning a page weight to each page individually by a predetermined process, wherein the page weight assigned to each page depends on one or more predetermined parameters and is not a constant value for all pages.

### BACKGROUND OF THE INVENTION

1. Field of the Invention

This invention relates to a method for determining the parameters responsible for ranking a page in a search mechanism. Precisely, this invention helps for ordering the web pages obtained during a search mechanism. More precisely, the present invention provides a computer-based method for finding convergence of ranking of a page in the process of assigning weight to a ranking parameter belonging to a web page said method comprising assigning a page weight to each page individually by a predetermined process, wherein the page weight assigned to each page depends on one or more predetermined parameters and is not a constant value for all pages.

2. Background of the Technology

Web surfers normally surf for the required information in several ways. One way is to go to the web site if the surfer has the knowledge of the web sites on which the information is available. The other way is to search for the information using some of the well known search engine and browses. In most of the cases, the user takes help from a search engine as it is practically not possible for the surfer to remember the address of each web page. It has therefore become famous that search engine strategies are more important and relevant to the user. Search engines are developing several applications to get the best out of the web and cater to the needs of the user. Another critical aspect is the size of the World Wide Web. There are millions of web pages on the WWW and the rate at which they are increasing is also alarming. Hence, it is difficult in this dynamically growing environment for the search engine to get the best of the web pages and order them so that the user finds the information required.

The result sub set of the WWW is therefore a large data set and these are to be served to the user. The user gets all of them in an order which is determined by the search engine. The user then browses a few tens or hundreds of web pages depending on the requirement and loses interest on the rest of the searched URLs. The one aspect of search engine is that of keeping these searched URLs in a ranked order. Several search engines have their own technical methods and implement their algorithms strategically in ordering the result set. The popularity of any search engine is dependent on the ranking order and therefore indirectly on the technical methods used to arrive at the raking.

The ordering of the result is therefore a result of an algorithm with some initial parameters and a process. Google, one of the famous search engines, uses an algorithm and uses in degree for ranking a page. In Google the initial weight for all pages are taken as unity and a damping factor 0.85 for voting another page.

Ranking a web page is often a difficult assignment because of complex architecture of the web. In the past years several researchers have computed the weight of a page through a predefined algorithm using term frequency or inverse document frequency (IDF). Reference may be made to Yuwono B., D. Lee, In Proc. of the 12th International Conference on the Data Engineering, New Orleans, La. (1996). pp 164-171. These ranks are based on text nature and key word. Google's algorithm introduced a new idea on page rank. The page ranking took a greater interest and more attention is given. Page click ratio, Cash algorithm, Statistical methods, Fuzzy logic approach, Text Retrieval Conference (TREC) and Artificial Intelligence methods are some of them to depend for page rank calculation. Thomas Hofmann, Unsupervised Learning by probabilistic Latent Semantic Analysis, Machine Learning Journal, 42(1), 177(2001) describes a process for calculating page rank using statistical methods. The web page http://buffy.eecs.berkeley.edu/IRO/Summary/02abstracts/nikravesh.1.html describes a process for calculating page rank using fuzzy logic approach. The web page http://www10.org/cdrom/papers/317/node9.html describes a process for calculating page rank using Text Retrieval Conference (TREC) approach. R. Armstrong, D. Freitag, T. Joachims, and T. Mitchell, WebWatcher: A learning apprentice for the World Wide Web, In Proc. 1995 AAAI Spring Symp. on Information Gathering from Heterogeneous, Distributed Environments, Stanford, March 1995, AAAI Press describes a process for calculating page rank using Artificial Intelligence methods. Kleinberg's HITS algorithm (Kleinberg M Jon, In Proc. of the ACM-SIAM Symposium on Discrete Algorithms, (ACM-SIAM, New York/Philadelphia, 1998) pp.668-677) also discusses about pages with hub and authority weights thus page rank is obtained for a keyword. It is difficult to make a particular page to be on top of search engines, because of the page rank mechanism or the content of the page. The search engines constantly undergo modifications of algorithms for the web architecture and thus place the popular pages on the top their result set. Google algorithm (refer web page: http://www-db.stanford.edu/˜backrub/google.html) uses the in-degree (the number of pages that points towards the page) which is an important factor and difficult to calculate in simple methods. Since the web is growing the in-degree depends mostly on the page importance and number of pages that are linking to this page. Google's Page rank is computed through an iterative algorithm and makes the ordering of the subset of WWW easy.

However in Google method, all the pages initially taken unity as its value and is being changed in process after each iteration. The page also has a factor 0.85 for voting to other page. Both of them are assumptions taken for the process of Google ranking. In the present invention, no assumptions are taken and each page has an initial value computed through another well-defined weighing schemes. The weighting factor is thus analyzed whether it could contribute for page ranking or not. There was no method earlier that a particular parameter chosen for weighting a page is really contributing or not.

| S. No | Prior method | Present method |
|---|---|---|
| 1 | Collection of pages | Same |
| 2 | Finding out no. of inward links, | Same |
| | outward links for each page | |
| 3 | Assign page weight as one to all | Assign page weight by a |
| | pages | software process where a |
| | | single parameter or |
| | | combination of parameters are |
| | | used as input and page weight |
| | | as output |
| 4 | Multiply the page weight 0.85 | Not there in this process |
| | (Voting factor) | |
| 5 | Divide the page weight with no. of | Same |
| | out going links | |
| 6 | Add this page weight to the next | Same |
| | linked page weight and assign to it | |
| 7 | Repeat the process 4, 5 and 6 till | Repeat the process 5 and 6 till |
| | the ranks are stabilized | the ranks are stabilized. |
| 8 | Verify for stabilization of page | Same. |
| | ranks till a large no of iterations | |
| | are performed | |

Page rank plays important role for a search engine to place the page in the order of the subset of WWW. Google [search] method uses in-degree (hyper link) based iterative algorithm for finding the page rank and thus delivers the pages to user. Initially Google uses unity as weight for all pages equally and a damping factor 0.85 for voting another page.

Another reference may be made to Lakshminarayana. S., Dynamic ranking with n+1 dimensional vector space models-An alternative search mechanism for World Wide Web. Journal of American society of Information Science and Technology, 53(14), 2002. Similar references may be made to U.S. Pat. Nos. 6,278,992 to Curtis et al., 6,219,827 to Richard et al., 6,321,228 to Crandall et al. and 6,285,999 to Page; Lawrence.

### SUMMARY OF THE INVENTION

Accordingly, the present invention provides a computer-based method for finding convergence of ranking of a page in the process of assigning weight to a ranking parameter belonging to a web page said method comprising assigning a page weight to each page individually by a predetermined process, wherein the page weight assigned to each page depends on one or more predetermined parameters and is not a constant value for all pages.

### DESCRIPTION OF THE FIGURES

FIG. 1: FIG. 1 represent the sub graph chosen for experiment 1 in the present invention. The arrows indicate existence of a link while the numbers indicate the page number in this experiment.

FIG. 2: FIG. 2 represent the sub graph chosen for experiment 2 in the present invention. The arrows indicate existence of a link while the numbers indicate the page number in this experiment.

FIG. 3: FIG. 3 represents the inputs to the files for Examples 1 and 2.

### BRIEF DESCRIPTION OF ACCOMPANYING TABLES

TABLE 1: Table 1 provides the information of ten files given in example 1. The no of href's i.e. out going links from that page, term frequency (tf wherein term frequency is the frequency of the term (search query) in that page), weight is the ratio of the term frequency to the number of out going links in the page, In degree (In deg.) is the in coming links to that page and out degree (out deg) is the out going links from that page.

TABLE 2: Table 2 compares the results obtained for example 1 by the method of the present invention and two other prior art methods. The prior art methods include GOOGLE method with voting factor and GOOGLE method without voting factor.

TABLE 3: Table 3 provides the information of ten files given in example 2. The no of href's i.e. out going links from that page, term frequency (tf wherein term frequency is the frequency of the term (search query) in that page), weight is the ratio of the term frequency to the number of out going links in the page, In degree (In deg.) is the in coming links to that page and out degree (out deg) is the out going links from that page.

TABLE 4: Table 4 compares the results obtained for example 2 by the method of the present invention and two other prior art methods. The prior art methods include GOOGLE method with voting factor and GOOGLE method without voting factor.

TABLE 5: Table 5 shows the ranking obtained for example 1 for 100 consecutive iterations by following the ranking method of the present invention.

TABLE 6: Table 6 shows the ranking obtained for example 1 for 100 consecutive iterations by following the Google method with voting factor.

TABLE 7: Table 7 shows the ranking obtained for example 1 for 100 consecutive iterations by following the Google method without voting factor.

TABLE 8: Table 8 shows the ranking obtained for example 2 for 100 consecutive iterations by following the ranking method of the present invention.

TABLE 9: Table 9 shows the ranking obtained for example 2 for 100 consecutive iterations by following the Google method with voting factor.

TABLE 10: Table 10 shows the ranking obtained for example 2 for 100 consecutive iterations by following the Google method without voting factor.

### DETAILED DESCRIPTION OF THE PRESENT INVENTION

A computer based method for finding convergence of ranking of a page in the process of assigning weight to a ranking parameter belonging to a web page the said process comprising steps of:

(a) collecting the web pages that have to be ranked from the web;

(b) calculating the number of inward links to each page (In Deg); number of outward links from each page (Out Deg); term frequency (tf) and number of gif tiff, bmp, p1 1or pdf files referred from the page;

(c) assigning a page weight to each page individually by a predetermined process, wherein the page weight assigned to each page depends on one or more parameters defined in step (b);

(d) obtaining page weight factor for all pages collected by individually dividing the weight of a particular page by the number of outgoing links from that page;

(e) adding the page weight factor obtained in step (d) to the page weight of all next linked pages to obtain a fresh page weight;

(f) ranking the fresh page weights obtained in step (e) in the ascending order, and

(g) repeating steps (d) and (f) iteratively till the ranks of the pages obtained in step (f) stabilize.

In an embodiment of the present invention wherein in step (a), selection of web pages is carried out by a predetermined method.

In another embodiment of the present invention wherein in step (b), the number of inward and outward links of a page are calculated using a software.

In yet another embodiment of the present invention wherein in step (c), the assigning includes identifying and processing the parameters of each web page by a predetermined process.

In still another embodiment of the present invention wherein in step (c), the assigning includes identifying the parameters for the pages that are available on Intranet, Internet or a computer based storage and retrieval based files.

In one more embodiment of the present invention wherein in step (c), the assigning includes processing the parameters of grouped files, compressed files, automatic or manually generated files and ranking the said files by a predetermined process.

In one another embodiment of the present invention wherein in step (c), the assigning includes processing the parameters of diagrams, bars, pictures, movie files, graphical or text.

In a further embodiment of the present invention wherein in step (c), the assigning includes processing lists, directories or bookmarks that are used for ranking and ordering diagrams, bars, pictures, movie files, graphical or text.

In an embodiment of the present invention wherein in step (c), the assigning includes characterization of the parameters of a web page on the basis of a rank mechanism, ordering and prioritization of the web page.

In another embodiment of the present invention wherein in step (c), the assigning includes identifying the parameters for the purpose of sorting the web pages includes diagrams, bars, pictures, movie files, graphical or text and also lists, directories or bookmarks that are used for ranking and ordering diagrams, bars, pictures, movie files, graphical or text.

In yet another embodiment of the present invention wherein in step (c), the assigning includes processing of parameters of multilingual files and other file formats.

In still another embodiment of the present invention wherein step (c), the assigning includes computing relevance of the parameters by a predetermined method.

In one more embodiment of the present invention, the assigning includes processing the relevance of the parameters by a predetermined method.

In one another embodiment of the present invention wherein in step (c), assigning a page weight is carried out by one of the processes based on total frequency of the key word, inverse document frequency, weighting schemes from TREC (Text Retrieval Extraction Conference).

In a further embodiment of the present invention the page weight assigned is the ratio between the term frequency and href, wherein href includes the keyword in the webpage and in html language, out degree and number of gif tiff, bmp, p1, pdf files referred from the page.

In an embodiment of the present invention wherein in step (e), addition of the page weight factor is carried out to all the next linked pages using methods such as total frequency of the key word, inverse document frequency, weighting schemes from TREC (Text Retrieval Extraction Conference).

In another embodiment of the present invention wherein in step (g) “repeating the steps (d) and (f) iteratively till the ranks of the pages obtained in step (f) stabilize” includes iterating steps (d) and (f) till ranking of the pages converge.

In this present work, the initial parameters for calculation of page rank are obtained from weights computed from other methods. Thus all pages do not have the same initial weight and there is no damping factor. Since all the pages do not contribute equally for a key word/phrase, the result set converged in less number of iterations if the parameter(s) chosen for ranking is/are contributor(s) for page rank computation. More number of pages too participated in defining the order the final subset. The major result in this process is proving a parameter chosen as initial parameter is a constituent of a web page ranking or not. This is proved by the convergence of the result set.

The present invention is further described with reference to the accompanying examples which are given by way of illustration and therefore, should not be construed to limit the scope of the invention in any manner.

### EXAMPLE 1

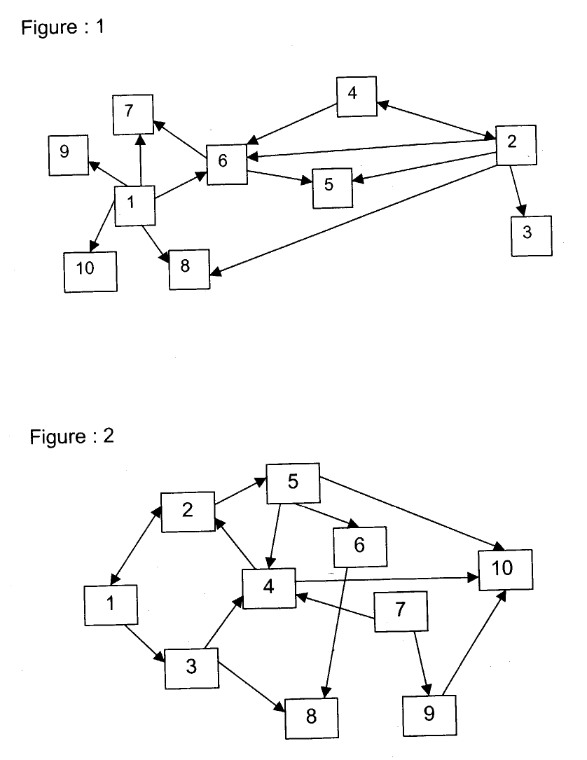

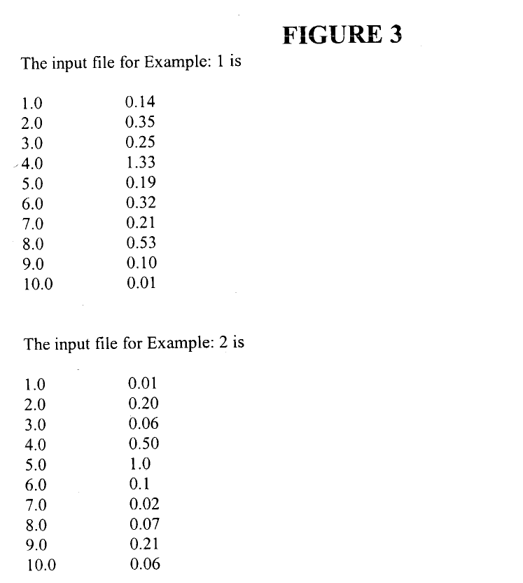

A subset of World Wide Web (WWW) chosen from the web and rank was computed for each page in respect to a key word. A sample of 10 pages is taken for experimentation and the pages are saved in text format. FIG. 1 represents the subset chosen for this experiment. The arrows indicate existence of a link while the numbers indicate the page numbers. The term frequency (tf) (number of keywords), numbers of out going links from the page (Out Deg), the number of incoming links to a page (In Deg), href are computed. The weight of a particular page is obtained as the ratio of the term frequency to that of href and the same is stored.

$$Weight = \frac{term frequency}{href}$$

Table 1 shows the various parameters like term frequency, number of incoming links, number of outgoing links, the href and the page weight of each page.

Page weight factor of individual page is obtained as the ratio between the page weight and the number of outgoing links

$$Page Weight Factor = \frac{Page Weight of the page}{Out Going Links from the page}$$

The page weight thus obtained is added to the page weight of all next linked pages to arrive at a fresh page weight. The pages are ranked in an ascending order depending upon the fresh page weight obtained.

The aforesaid process is iterated till the ranks of the pages obtained in step (f) stabilize and or in other words, till a convergence of the raking is obtained. The results of the first 100 iterations by following the method of the present invention is tabulated in Table 5. Google's algorithm with voting factor and Google's algorithm without employing voting factor are also applied to the same set of data and the weight of the page are calculated and iterated till a convergence was obtained. The results of the first 100 iterations by following the Google's algorithm with voting factor is tabulated in table 6 whereas the results of the first 100 iterations by following the Google's algorithm without voting factor is tabulated in table 7. Table 2 gives a comparison of all the three methods. In table 2, the result where there is a change in rank order is given and intermediate iterations follow the previous rank order.

### Example 2

A subset of World Wide Web (WWW) chosen from the web and rank was computed for each page in respect to a key word. A sample of 10 pages is taken for experimentation and the pages are saved in text format. FIG. 2 represents the subset chosen for this experiment. The arrows indicate existence of a link while the numbers indicate the page numbers. The term frequency (tf) (number of keywords), numbers of out going links from the page (Out Deg), the number of incoming links to a page (In Deg), href are computed. The weight of a particular page is obtained as the ratio of the term frequency to that of href and the same is stored.

$$Weight = \frac{term frequency}{href}$$

Table 3 shows the various parameters like term frequency, number of incoming links, number of outgoing links, the href and the page weight of each page.

Page weight factor of individual page is obtained as the ratio between the page weight and the number of outgoing links

$$Page Weight Factor = \frac{Page Weight of the page}{Out Going Links from the page}$$

The page weight thus obtained is added to the page weight of all next linked pages to arrive at a fresh page weight. The pages are ranked in an ascending order depending upon the fresh page weight obtained.

The aforesaid process is iterated till the ranks of the pages obtained in step (f) stabilize and or in other words, till a convergence of the raking is obtained. The results of the first 100 iterations by following the method of the present invention is tabulated in Table 8. Google's algorithm with voting factor and Google's algorithm without employing voting factor are also applied to the same set of data and the weight of the page are calculated and iterated till a convergence was obtained. The results of the first 100 iterations by following the Google's algorithm with voting factor is tabulated in table 9 whereas the results of the first 100 iterations by following the Google's algorithm without voting factor is tabulated in table 10. Table 4 gives a comparison of all the three methods. In table 4, the result where there is a change in rank order is given and intermediate iterations follow the previous rank order.

It can be noticed that the orders in all the three methods are same after few hundred iterations. Table no 2 and 4 results show that rank order is more or less similar to that of Google results. The number of pages participated in the present method in several iterations are more compared to Google method. The initial weights for a page are taken from the ratio of term frequency to that of the number of outward links in that page in the present method.

It should be noticed that page rank is a contribution of multi-dimensional parameters. Such parameters could be obtained from computing the order using the method of the present invention and comparing the parameters thus obtained with standard search engine results like Google. If the result set satisfies the order, one can conclude that the initial parameter chosen for the computation is relevant for ranking of the web page

The method of the present invention uses the initial parameters different from that used by GOOGLE and hence the method of the present invention is able to get better order in less number of iterations with the changed initial parameters.

By following the method of the present invention, we can identify the parameters that contribute to the ranking of a page and eliminate those parameters that do not contribute to the ranking. Thus the parameter could be identified whether it is a constituent or not. After getting the result set, we can conclude that the initial parameter that is chosen for computation of page rank is a constituent of a web page or not. If the result set diverges with this method, it can be concluded that the initial parameter does not contribute for page ranking for the particular key word.

Various parameters like term frequency, in degree, out degree, no of words of the page, no of pictures etc can be examined and some of them will contribute for page rank and others will not. The Inventors have found during the experiments that term frequency, in degree, out degree are some of the factors which contribute for page ranking whereas number of pictures in the page do not contribute for page rank. Currently no method or research is established to prove this fact. The method of the present invention proposes an idea and establishes a fact for finding whether a particular parameter is a contributor or not for ranking of the page.

The method of the present invention can also be used to classify various parameters of a page for relevance of ranking. After establishing the fact that some parameters will contribute for page rank and others will not contribute, the method of the present invention also classifies them.

The method of the present invention further groups the parameters. This extends for explanation of (d) above. In the present method it is established that some parameters are contributing for page rank and others do not. This method also enables a person to understand the relevance of contribution by comparing the results of one parameter with others. In the present method, the rank order is the result set, the iteration number are the input parameters and relevance can be computed by a ratio and thereby grouping can be made.

The method of the present invention also achieves the same result by choosing new initial parameters for computation of page rank.

By defining these initial parameters to the page and after reviewing the results thus obtained we can:

1. If the result set satisfies the order, conclude that the initial parameter chosen for computation is relevant for ranking of the web page.

2. Identify the parameters that contribute for page rank.

3. Classify various parameters of a page for relevance of ranking.

4. Group the parameters based upon the classification.

In the present invention it is also proved that more number of web pages are participated in each iteration for fixing a rank to it or in other words the rank order of a web page is changed several times in this process. It should be noticed that in the Google algorithm, subsets are formed in the chosen set of pages and ranking of the pages is done in the subsets. However, the method of the present of the present invention not only considers the pages in smaller subsets but also considers the pages collected in totality thereby arriving at a better ranking in lesser number of iterations.

It is also proved that the sub set of the WWW is converging if we consider the chosen initial parameters are contributors for web page ranking. If the chosen initial parameters are not contributors for web page ranking, the sub set of the WWW is diverging.

### ADVANTAGES OF THE PRESENT INVENTION

1. The method of the present invention can be used for validating the relevance of a new initial parameter for ranking of a web page.

2. If the result set satisfies the order, conclude that the initial parameter chosen for computation is relevant for ranking of the web page.

3. The present invention can be used to identify the parameters that contribute for page rank.

4. The present invention can be used to classify various parameters of a page for relevance of ranking.

5. The present invention can be used to group the parameters based upon the classification.

6. As large number of pages participate in the method, better and faster results are obtained.

TABLE 1
Input for Example 1

| S. No | href | tf | Weight | In deg | Out deg |
|---|---|---|---|---|---|
| 1 | 42 | 6 | 0.14 | 0 | 5 |
| 2 | 23 | 8 | 0.35 | 1 | 5 |
| 3 | 28 | 7 | 0.25 | 1 | 0 |
| 4 | 3 | 4 | 1.33 | 1 | 2 |
| 5 | 36 | 7 | 0.19 | 2 | 0 |
| 6 | 19 | 6 | 0.32 | 3 | 2 |
| 7 | 120 | 25 | 0.21 | 2 | 0 |
| 8 | 17 | 9 | 0.53 | 2 | 0 |
| 9 | 30 | 3 | 0.10 | 1 | 0 |
| 10 | 112 | 1 | 0.01 | 1 | 0 |

TABLE 2
Comparative results for Example 1

| | | Google with | Google with out |
|---|---|---|---|
| | This method | voting factor | voting factor |
| NO | Rank order | Rank order | rank order |
| 1 | 4, 6, 2, 8, 5, 7, 3, 1, | 6, 5, 7, 2, 8, 3, 4, 9, | 6, 5, 7, 2, 8, 3, 4, 9, |
| | 9, 10 | 10, 1 | 10, 1 |
| 2 | 6, 2, 4, 5, 7, 8, 3, 9, | | |
| | 1, 10 | | |
| 3 | 6, 2, 5, 7, 4, 8, 3, 9, | 5, 7, 6, 2, 8, 3, 4, 9, | 5, 7, 6, 2, 8, 3, 4, 9, |
| | 1, 10 | 10, 1 | 10, 1 |
| 4 | 6, 5, 7, 2, 4, 8, 3, 9, | | |
| | 1, 10 | | |
| 5 | 5, 6, 7, 2, 4, 8, 3, 9, | | |
| | 10, 1 | | |
| 6 | 5, 7, 6, 2, 4, 8, 3, 9, | | |
| | 10, 1 | | |
| 29 | 5, 7, 6, 2, 8, 4, 3, 9, | | |
| | 10, 1 | | |
| 64 | 5, 7, 6, 2, 3, 4, 8, 9, | | |
| | 10, 1 | | |
| 77 | 5, 7, 6, 2, 8, 3, 4, 9, | | |
| | 10, 1 | | |
| 80 | 5, 7, 6, 2, 3, 4, 8, 9, | | |
| | 10, 1 | | |
| 82 | | | 5, 7, 6, 2, 3, 4, 8, 9, |
| | | 10, 1 | |
| 89 | | 5, 7, 6, 2, 3, 4, 8, 9, | |
| | | 10, 1 | |
| 92 | 5, 7, 6, 2, 8, 3, 4, 9, | | |
| | 10, 1 | | |
| 100 | 5, 7, 6, 2, 8, 3, 4, 9, | 5, 7, 6, 2, 3, 4, 8, 9, | 5, 7, 6, 2, 3, 4, 8, 9, |
| | 10, 1 | 10, 1 | 10, 1 |
| 200 | 5, 7, 6, 2, 3, 4, 8, 9, | same | same |
| | 10, 1 | | |
| 300 | same | same | same |

TABLE 3
Input for Example 2

| S. No | Weight | In deg | Out deg |
|---|---|---|---|
| 1 | 0.01 | 1 | 2 |
| 2 | 0.20 | 2 | 2 |
| 3 | 0.06 | 1 | 2 |
| 4 | 0.50 | 3 | 2 |
| 5 | 1.0 | 1 | 3 |
| 6 | 0.10 | 1 | 1 |
| 7 | 0.02 | 0 | 2 |
| 8 | 0.07 | 2 | 0 |
| 9 | 0.21 | 1 | 1 |
| 10 | 0.06 | 3 | 0 |

TABLE 4
Comparative results for Example 2

| | | | Google with out |
|---|---|---|---|
| | This method | Google with voting | voting factor |
| NO | rank order | factor rank order | rank order |
| 1 | 5, 4, 10, 2, 6, 9, 8, | 10, 8, 4, 2, 1, 3, 5, | 10, 8, 4, 2, 1, 3, 5, |
| | 1, 3, 7 | 9, 6, 7 | 9, 6, 7 |
| 2 | 10, 5, 4, 2, 6, 8, 1, | 10, 8, 4, 2, 1, 5, 3, | 10, 8, 4, 2, 1, 5, 3, |
| | 9, 3, 7 | 9, 6, 7 | 9, 6, 7 |
| 3 | 10, 5, 4, 2, 8, 6, 1, | 10, 8, 2, 4, 1, 5, 3, | 10, 8, 2, 4, 1, 5, 3, |
| | 3, 9, 7 | 6, 9, 7 | 6, 9, 7 |
| 4 | | 10, 2, 8, 4, 1, 5, 3, | 10, 2, 8, 4, 1, 5, 3, |
| | | 6, 9, 7 | 6, 9, 7 |
| 5 | 10, 2, 8, 5, 4, 1, 6, | | |
| | 3, 9, 7 | | |
| 7 | | | 10, 1, 8, 1, 5, 4, 3, |
| | | | 6, 9, 7 |
| 8 | 10, 2, 8, 5, 1, 4, 3, | 10, 2, 8, 1, 5, 4, 3, | |
| | 6, 9, 7 | 6, 9, 7 | |
| 9 | 2, 10, 8, 5, 1, 4, 3, | | 2, 10, 8, 1, 5, 4, 3, |
| | 6, 9, 7 | | 6, 9, 7 |
| 10 | 2, 8, 10, 5, 1, 4, 3, | 2, 10, 8, 1, 5, 4, 3, | |
| | 6, 9, 7 | 6, 9, 7 | |
| 18 | | | 2, 8, 10, 1, 5, 4, 3, |
| | | | 6, 9, 7 |
| 100 | 5, 7, 6, 2, 8, 3, 4, 9, | 5, 7, 6, 2, 3, 4, 8, 9, | 5, 7, 6, 2, 3, 4, 8, 9, |
| | 10, 1 | 10, 1 | 10, 1 |
| 200 | 5, 7, 6, 2, 3, 4, 8, 9, | same | same |
| | 10, 1 | | |
| 300 | same | same | same |

TABLE 5
Rank Order obtained for Example 1 by following the method
of the present invention for 100 consecutive iterations

| | | | | | | | | | |
|---|---|---|---|---|---|---|---|---|---|
| 4 | 6 | 2 | 8 | 5 | 7 | 3 | 1 | 9 | 10 |
| 6 | 2 | 4 | 5 | 7 | 8 | 3 | 9 | 1 | 10 |
| 6 | 2 | 5 | 7 | 4 | 8 | 3 | 9 | 1 | 10 |
| 6 | 5 | 7 | 2 | 4 | 8 | 3 | 9 | 1 | 10 |
| 5 | 6 | 7 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 4 | 8 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 4 | 3 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |

TABLE 6
Rank Order obtained for Example 1 by following the method of
Google with voting factor for 100 consecutive iterations

| | | | | | | | | | |
|---|---|---|---|---|---|---|---|---|---|
| 6 | 5 | 7 | 2 | 8 | 3 | 4 | 9 | 10 | 1 |
| 6 | 5 | 7 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |

TABLE 7
Rank Order obtained for Example 1 by following the method of
Google without voting factor for 100 consecutive iterations

| | | | | | | | | | |
|---|---|---|---|---|---|---|---|---|---|
| 6 | 5 | 7 | 2 | 8 | 3 | 4 | 9 | 10 | 1 |
| 6 | 5 | 7 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 8 | 3 | 4 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |
| 5 | 7 | 6 | 2 | 3 | 4 | 8 | 9 | 10 | 1 |

TABLE 8
Rank Order obtained for Example 2 by following the method
of the present invention for 100 consecutive iterations

| | | | | | | | | | |
|---|---|---|---|---|---|---|---|---|---|
| 5 | 4 | 10 | 2 | 6 | 9 | 8 | 1 | 3 | 7 |
| 10 | 5 | 4 | 2 | 6 | 8 | 1 | 9 | 3 | 7 |
| 10 | 5 | 4 | 2 | 8 | 6 | 1 | 3 | 9 | 7 |
| 10 | 2 | 8 | 5 | 4 | 6 | 1 | 3 | 9 | 7 |
| 10 | 2 | 8 | 5 | 4 | 1 | 6 | 3 | 9 | 7 |
| 10 | 2 | 8 | 5 | 4 | 1 | 6 | 3 | 9 | 7 |
| 10 | 2 | 8 | 5 | 4 | 1 | 6 | 3 | 9 | 7 |
| 10 | 2 | 8 | 5 | 1 | 4 | 3 | 6 | 9 | 7 |
| 2 | 10 | 8 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 5 | 1 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |

TABLE 9
Rank Order obtained for Example 2 by following the method of
Google with voting factor for 100 consecutive iterations

| | | | | | | | | | |
|---|---|---|---|---|---|---|---|---|---|
| 10 | 8 | 4 | 2 | 1 | 3 | 5 | 9 | 6 | 7 |
| 10 | 8 | 4 | 2 | 1 | 5 | 3 | 9 | 6 | 7 |
| 10 | 8 | 2 | 4 | 1 | 5 | 3 | 6 | 9 | 7 |
| 10 | 2 | 8 | 4 | 1 | 5 | 3 | 6 | 9 | 7 |
| 10 | 2 | 8 | 4 | 1 | 5 | 3 | 6 | 9 | 7 |
| 10 | 2 | 8 | 4 | 1 | 5 | 3 | 6 | 9 | 7 |
| 10 | 2 | 8 | 1 | 5 | 4 | 3 | 6 | 9 | 7 |
| 10 | 2 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |

TABLE 10
Rank Order obtained for Example 2 by following the method of
Google without voting factor for 100 consecutive iterations

| | | | | | | | | | |
|---|---|---|---|---|---|---|---|---|---|
| 10 | 8 | 4 | 2 | 1 | 3 | 5 | 9 | 6 | 7 |
| 10 | 8 | 4 | 2 | 1 | 5 | 3 | 9 | 6 | 7 |
| 10 | 8 | 2 | 4 | 1 | 5 | 3 | 6 | 9 | 7 |
| 10 | 2 | 8 | 4 | 1 | 5 | 3 | 6 | 9 | 7 |
| 10 | 2 | 8 | 4 | 1 | 5 | 3 | 6 | 9 | 7 |
| 10 | 2 | 8 | 4 | 1 | 5 | 3 | 6 | 9 | 7 |
| 10 | 2 | 8 | 4 | 1 | 5 | 3 | 6 | 9 | 7 |
| 10 | 2 | 8 | 1 | 5 | 4 | 3 | 6 | 9 | 7 |
| 10 | 2 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 10 | 8 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |
| 2 | 8 | 10 | 1 | 5 | 4 | 3 | 6 | 9 | 7 |

What is claimed is:

1. A computer based method for finding convergence of ranking of a page in the process of assigning weight to a ranking parameter belonging to a web page the said process comprising steps of:
(a) collecting the web pages that have to be ranked from the web;
(b) calculating the number of inward links to each page (In Deg); number of outward links from each page (Out Deg); term frequency (tf) and number of gif, tiff, bmp, p1 or pdf files referred from the page;
(c) assigning a page weight to each page individually by a predetermined process, wherein the page weight assigned to each page depends on one or more parameters defined in step (b);
(d) obtaining page weight factor for all pages collected by individually dividing the weight of a particular page by the number of outgoing links from that page;
(e) adding the page weight factor obtained in step (d) to the page weight of all next linked pages to obtain a fresh page weight;
(f) ranking the fresh page weights obtained in step (e) in the ascending order, and
(g) repeating steps (d) and (f) iteratively till the ranks of the pages obtained in step (f) stabilize.

2. A method as claimed in claim 1, wherein in step (a) selection of web pages is carried out by a predetermined method.

3. A method as claimed in claim 1, wherein in step (b) the number of inward and outward links of a page are calculated using a software.

4. A method as claimed in claim 1, wherein in step (c) the assigning includes identifying and processing the parameters of each web page by a predetermined process.

5. A method as claimed in claim 1, wherein in step (c) the assigning includes identifying the parameters for the pages that are available on Intranet, Internet or a computer based storage and retrieval based files.

6. A method as claimed in claim 1, wherein in step (c) the assigning includes processing the parameters of grouped files, compressed files, automatic or manually generated files and ranking the said files by a predetermined process.

7. A method as claimed in claim 1, wherein in step (c) the assigning includes processing the parameters of diagrams, bars, pictures, movie files, graphical or text.

8. A process as claimed in claim 7, wherein in step (c) the assigning includes processing lists, directories or bookmarks that are used for ranking and ordering diagrams, bars, pictures, movie files, graphical or text.

9. A method as claimed in claim 1, wherein in step (c) the assigning includes characterization of the parameters of a web page on the basis of a rank mechanism, ordering and prioritization of the web page.

10. A method as claimed in claim 1, wherein in step (c) the assigning includes identifying the parameters for the purpose of sorting the web pages that are specified in claims 7 and 8.

11. A method as claimed in claim 1, wherein in step (c) the assigning includes processing of parameters of multilingual files and other file formats.

12. A method as claimed in claim 1, wherein step (c) the assigning includes computing relevance of the parameters by a predetermined method.

13. A method as claimed in claim 12, wherein the assigning includes processing the relevance of the parameters by a predetermined method.

14. A method as claimed in claim 1, wherein in step (c) assigning a page weight is carried out by one of the processes based on total frequency of the key word, inverse document frequency, weighting schemes from TREC (Text Retrieval Extraction Conference).

15. A method as claimed in claim 1, wherein the page weight assigned is the ratio between the term frequency and href, wherein href includes the keyword in the webpage and in html language, out degree and number of gif tiff, bmp, p1, pdf files referred from the page.

16. A method as claimed in claim 1, wherein in step (e) addition of the page weight factor is carried out to all the next linked pages using one of the methods as claimed in claim 14.

17. The method in claim 1, wherein in step (g) “repeating the steps (d) and (f) iteratively till the ranks of the pages collected in step (a) stabilize” includes iterating steps (d) and (f) till the ranking of the pages converge.
